(19) United States
(12) Patent Application Publication
(10) Pub. No.: US 2025/0217355 A1
(43) Pub. Date: Jul. 3, 2025

(54) LINEAR ALGEBRA TECHNIQUES IN A DATABASE MANAGEMENT SYSTEM

(71) Applicant: Teradata US, Inc., San Diego, CA (US)

(72) Inventor: Paul Brown, Concord, MA (US)

(73) Assignee: Teradata US, Inc., San Diego, CA (US)

(21) Appl. No.: 19/007,410

(22) Filed: Dec. 31, 2024

Related U.S. Application Data
(60) Provisional application No. 63/616,722, filed on Dec. 31, 2023.

(51) Int. Cl. G06F 16/242

(52) U.S. Cl. CPC G06F 16/2448

(57) ABSTRACT

Various techniques may be employed in a system, method, and computer-readable medium to allow declarative database syntax language to accommodate matrix multiplication.

### CLAIM OF PRIORITY

This application claims the benefit of priority under 35 U.S.C. § 119(e) of U.S. Provisional Patent Application Ser. No. 63/616,722 filed on Dec. 31, 2023, which is hereby incorporated by reference herein in its entirety.

### BACKGROUND

SQL query processing involves taking a high-level declarative programming language expression—a SQL query—compiling it into an efficient execution plan consisting of a series of logical operators—the overall pool of logical operations comprising a closed set-theoretic algebra—and assigning each operator in this plan a low-level data manipulation algorithm. The exact algorithm is determined by factors such as the amount of data or other physical properties. Efficiently implementing modern analytic methods—machine learning and deep learning, etc.—requires building blocks, which are not part of the traditional relational tool kit. To provide a flexible and efficient platform for performing machine learning and deep learning methods it is necessary to extend the traditional set-theoretic algebra to include linear algebra operators.

Because traditional LLMs are limited by input limitations, it would be desirable to design inputs to allow an LLM to have a more expansive input set to make workload compression decisions.

### SUMMARY

According to various aspects of the disclosure, various techniques may be employed in a system, method, and computer-readable medium to allow declarative database syntax language to accommodate matrix multiplication.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is an example of a small schema.

FIG. 6 is table of an example of 600 how logical operators are defined in terms of their parameters and semantics.

FIG. 7 is an example of operator reordering.

FIG. 8 is an example of a manner in which matrices may be represented in a database.

FIG. 9 is a table listing example logical operators and physical algorithms for matrix transpose and multiplication.

FIG. 10 is an example of operator manipulation to manage matrix multiplication.

FIG. 11 is an example of potential interaction between a relational and linear algebra operators.

FIG. 12 is an example of matrix multiplication operations.

FIGS. 13A and 13B are examples of variations on how matrix multiplication sub-steps may be altered for efficiency.

FIG. 14 is an example of linear algebra operator reordering.

FIG. 15 is an example of various techniques that may be implemented to allow declarative database syntax to manage matrix multiplication.

### DETAILED DESCRIPTION OF THE FIGURES

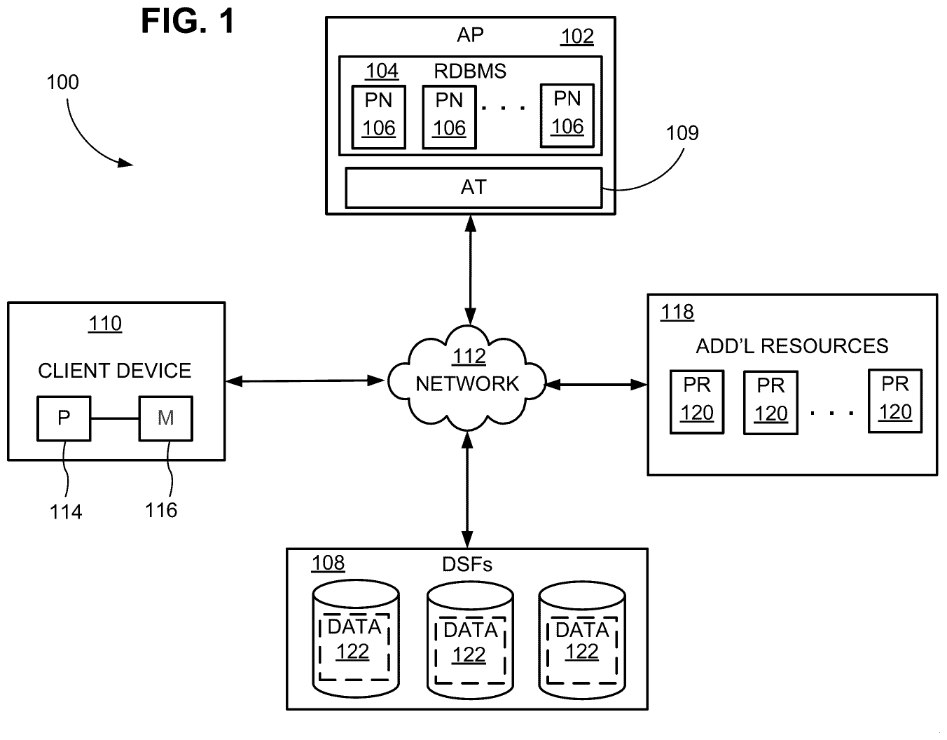

FIG. 1 is a block diagram of an example analytic environment 100. In one example, the analytic environment 100 may include an analytic platform (“AP”) 102, such as Teradata Vantage. The analytic platform 102 may include one or more systems that may be used independently or with one another in conducting advanced analytics. The analytic platform 102 may include a relational database management system (“RDBMS”) 104. In one example, the RDBMS 104 may implement a parallel-processing environment to conduct database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The DSFs 108 may represent various types of storage, such as persistent and/or non-persistent, for example. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, and/or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

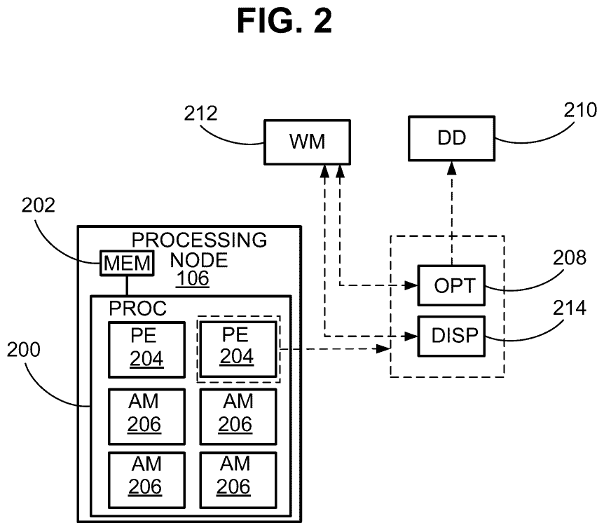

FIG. 2 is an example of a processing node 106, which may include one or more physical processors 200 and memory(ies) 202. Memory(ies) 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking. parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, which includes instructions executable with the processor 200 or other processor to implement one or more of the features of the module. When any one of the modules includes the portion of the memory 202 that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Vantage analytic platform, for example.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIGS. 1-2, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 104 stores data 122 in one or more tables (or other data object formats) in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

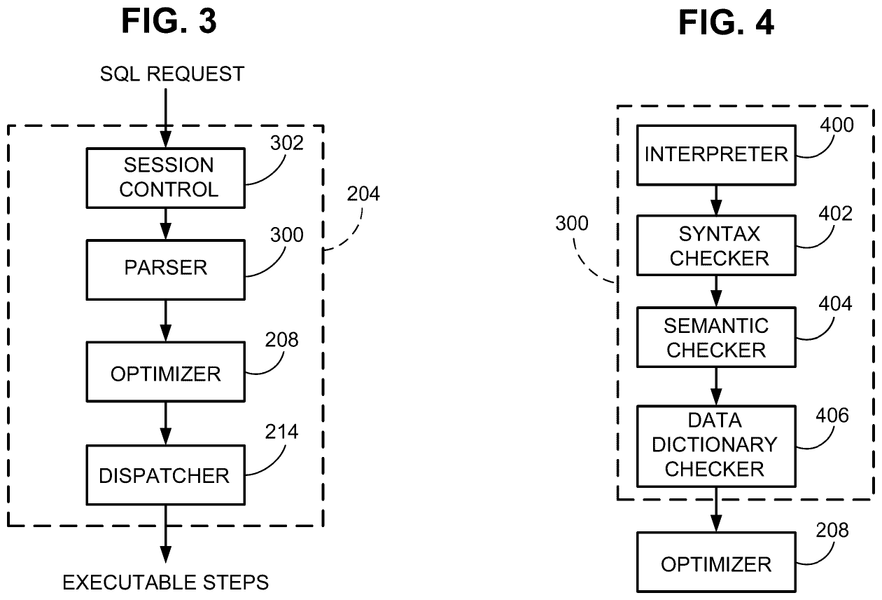

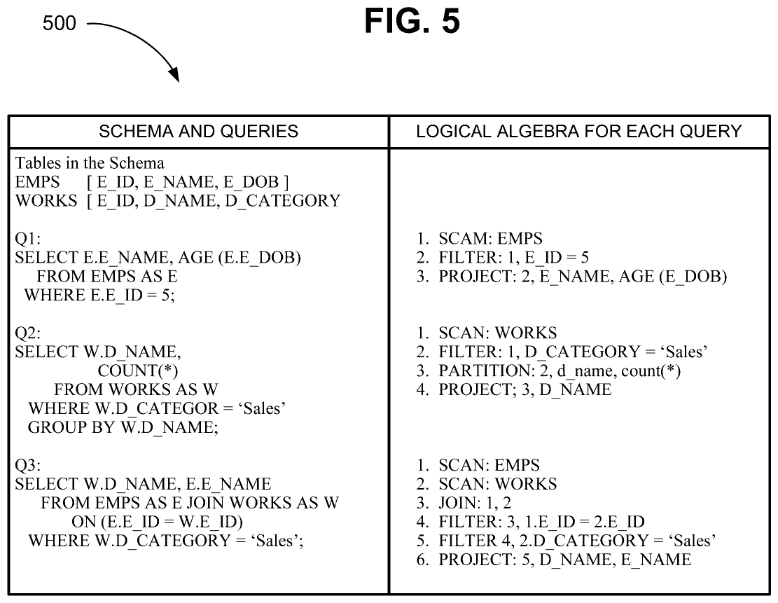

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 204 for purposes of illustration.

The data dictionary module 210, which may reside in the RDBMS 104, may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212, which may be executed within the RDBMS 104 by one or more processing nodes 106. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission the client device 110 and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

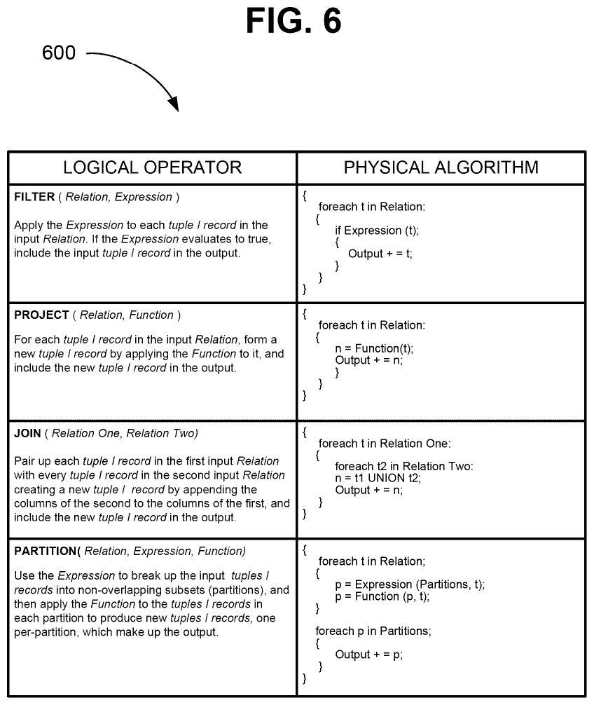

In one example, various implementations may be made to allow the RDBMS 104 to more efficiently handle complex linear algebraic tasks (i.e., matrix multiplication and matrix transposition) using a declarative database language such as SQL Expressions in SQL describe at a high level what users want the RDBMS 104 to compute for them—given the context of some database schema—and the RDBMS 104 implementation determines how an expression is to be computed using a planned sequence of physical data manipulation operations. FIG. 5 is an example of a small schema 500. The right column of the schema 500 includes a (representative) subset of the logical operators that constitute the dynamic—that is, data transforming—elements of the body of theory making up the “relational data model”. Each such operator:
Takes as input one or two relations (sets).
Returns as output exactly one relation.
Sometimes—see FILTER and JOIN—also takes an expression parameter that the operator applies to the input data to transform the input.
Sometimes—see PROJECT—also takes a parameter (a function) that specifies some structural change to the input.
Sometimes—see PARTITION—takes both kinds of parameters.
   Note that the SCAN operator as presented here is scaffolding for tying operator sequences to schema elements.

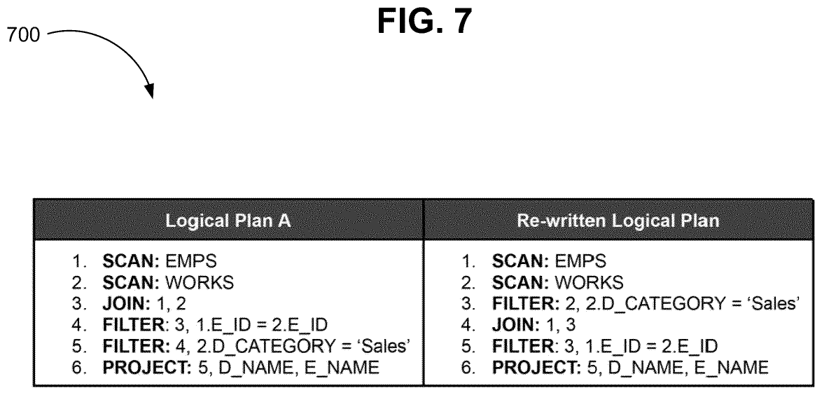

FIG. 6 provides a table 600 that illustrates how these logical operators are defined in terms of their parameters and semantics; that is, what each takes as input and the transformation each operator makes to its inputs to generate its outputs. Also provided is a simple imperative algorithm to illustrate the corresponding physical operator.

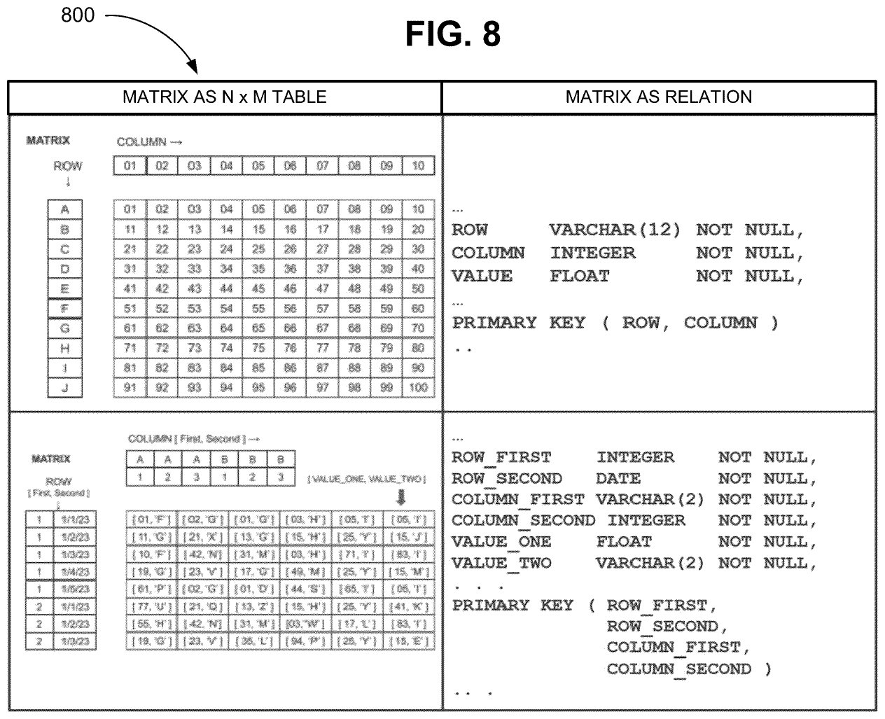

SQL query processing depends on (at least) two properties of this algebraic foundation: closure and operator reordering. Closure simply means that the output of one operator can be immediately consumed as input to another. Closure allows for the creation of arbitrarily long chains of operators which cumulatively implement very complex data manipulation tasks. Operator reordering is a consequence of the mathematical properties of relational operators. In technical terms, relational operators are commutative (that is, Op (Input_One, Input_Two) can be re-written as Op (Input_Two, Input_One)) and associative (that is, Op) (Op₂ Input)) can be re-written as Op₂ (Op₁ Input)). In practical terms, this means that a sequence of operators can be rearranged into a more efficient order. For example, in the following example, pushing the WORKS specific filter before the JOIN operator will reduce the amount of data that the JOIN must handle thereby reducing the total computational resources the query requires. An example of this is shown in FIG. 7 in table 700.

What these properties lead to is a situation where any non-trivial logical plan can be rearranged into many alternative forms and the query compiler is free to pick the individual plan it estimates will incur the lowest computational cost. To estimate the physical cost of a particular plan and to choose the most appropriate physical algorithm for individual operators, the SQL implementation relies on statistics about the data in the schema—number of rows, etc. Adding linear algebra operators to this mix should strive to preserve these properties. Inputs to and output from linear algebra operators need to be sets of tuples/records. The query planner needs to know how to rearrange operators. The statistics gathered should be capable of informing cost estimation for the new operators. As things stand, no SQL implementation includes support for linear algebra operators, and . . .

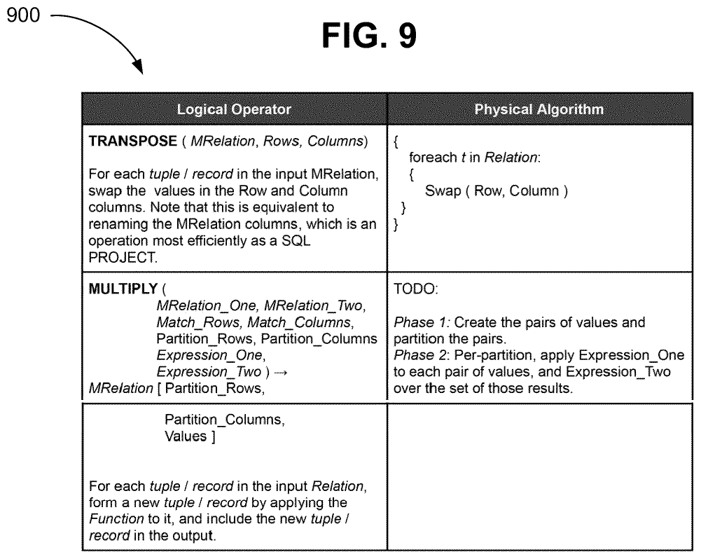

The mechanisms described here focus on two new operators generally associated with matrix operations in the linear algebra: TRANSPOSE and MULTIPLY. These operators will take as input and return as output matrices organized as relations—that is, [ROW, COLUMN, VALUE] triples. Row and column indices and per-cell values can be compound—that is, [ROW_ID_ONE, ROW_ID_TWO, COLUMN_ID_ONE, COLUMN_ID_TWO, VALUE_ONE, VALUE_TWO]. FIG. 8 provides a table 800 illustrating an example of how matrices may be represented. One way to consider this organizational model is to think of matrices as a kind of mapping from the index/coordinates space into (for example) the domain of reals. That is, a 2D matrix can be:

$$F : [ Row , Column ] \to R$$

From a relational theory perspective, this corresponds to a function dependency from the row, column columns to the value columns. We represent this as a primary key in the figure above. Representing matrices and arrays this way has lots of advantages over alternatives proposed or implemented elsewhere.
There is no limit to how big (dimension size) a matrix can be. Further, all of the storage infrastructure built to support very large tables and interim query results will apply with matrices.
The semantics of dimensional indices and per-cell values can be made to reflect the semantics of the problem domain far more closely than (for example) integers or single scalar values. In addition, all of the administrative machinery supported in SQL—ALTER TABLE, access control, etc—applies.
Any number of common matrix operations—e.g. slicing vectors and blocks, Matrix Addition, Scalar Product, Hadamard Product, Kronecker Product—all have very straightforward and efficient SQL implementations. That is, there is no need to define a new language or implement a functional interface.
All external APIs—ODBC, JDBC, etc.—will work without alteration.
The logic is independent of physical questions such as whether the matrix is dense or sparse, and SQL is flexible enough to support per-cell filtering, and sophisticated techniques like alternate semi-rings.

The singular difficulty with the matrices-as-tables approach is that the SQL version of the principle matrix operation—matrix multiplication—is very inefficient relative to the methods used in high performance computing, which directly implements matrix multiply as a low-level “building block” algorithm, and employs specialized data structures and careful designed parallel algorithms. In addition, over time practitioners have built up a considerable body of research and experience providing guidance as to which selection of algorithm and data structure is to be preferred in particular circumstances.

What all of this suggests is that a declarative approach to matrix operations is not only possible but comes with a number of advantages. The central idea is to extend the set of relational operators that are the semantic foundation of SQL to include matrix multiply. Then we can draw on the best practices followed in the HIP community to optimize high level declarative (that is, what expressions) into low level imperative (that is, sequences of physical methods specifying how the operation is to be computed).

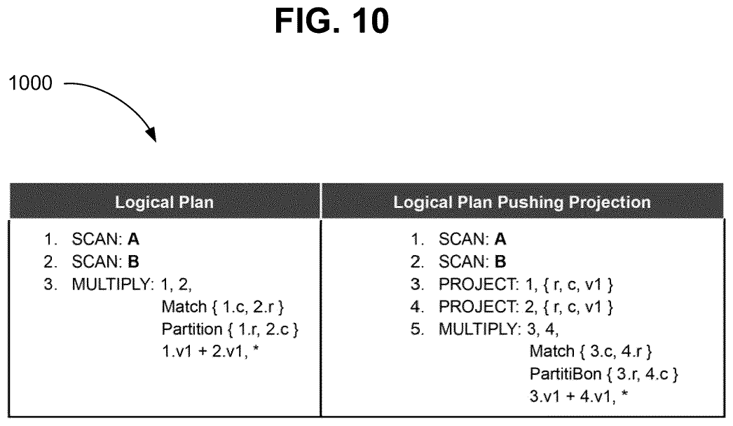

FIG. 9 is a table 900 listing the logical operators and physical algorithms for matrix transpose and multiplication. Regarding the MULTIPLY operation's semantics:
The usual way matrix multiply is described is some form of A_{n,m}×B_{m,p}→C_{n,p}. That is, the operation is described in terms of multiplying one matrix A of n rows and m columns by another matrix B having m rows and p columns to produce as output a third matrix C having n rows and p columns. The assumption is that this operation can only be meaningfully defined when Aₘ=Bₘ. That is, when the number of columns in A equals the number of rows in B. An important variant on this prescription arises when we consider sparse matrices: that is, matrices where a zero value in a cell is taken to mean that the cell is empty, which means there is no row in the MRelation having that combination of row, column values. Which makes it possible that there exists an entire column of A or row of B containing only zero values, and therefore that the number of rows and columns in the output has a maximum of Aₙ and Bₚ.
In turn, the physical cost of the MULTIPLY calculation has an upper bound of O(n×m×p) and an output size of n×p, but sparse inputs may dramatically reduce this. ¹We return to this case later when we consider what statistical evidence we can use to estimate the actual cost and output size of sparse operations. We also note that MULTIPLY is an operator with a cost that is vastly greater than any other operator in the relational model which makes query planning even more important.

With the concepts in mind, in one example the optimizer 208 may be designed to more efficiently plan queries involving algebraic operators. In one example, the optimizer 208 may handle logical planning of the query. Logical query planning involves starting with an expression that consists of a sequence of logical operators, reordering or otherwise manipulating those operators into alternative, but logically equivalent sequences, and then selecting the sequence identified as having the lowest “cost”. Therefore, an essential element of the logical query planning process is an understanding of the rules governing such re-arrangements. The focus of this disclosure involves reordering or otherwise manipulating mixtures of linear algebra operators and relational operators. That is, once the linear algebra operators are included into the SQL language, efficient query processing will require that the query planner can explore a space of possible logical plans generated by rearranging a mix of operator types into logically equivalent forms.

Three examples are provided to illustrate how this method would be applied in practice. All of the examples below work against a schema consisting of three matrix relations (“MRelations”) A[r, c, v1, v2], B[r, c, v1, v2] and C[r, c, v1, v2].

### Pushing PROJECT Through MULTIPLY

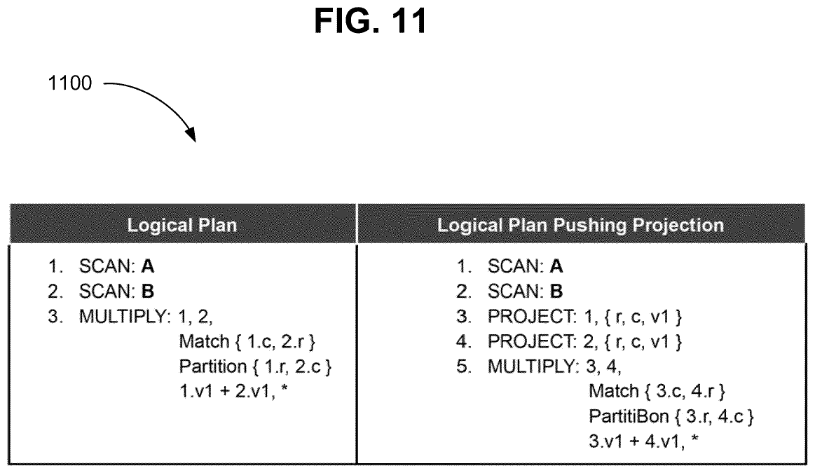

This is a very simple rule for manipulating a logical query plan. From the syntax and semantics of MULTIPLY it is possible to automatically generate the subset of columns required from the inputs. Then by injecting a PROJECT operator into the logical plan before the MULTIPLY. FIG. 10 includes table 1000 to illustrates how this works. In isolation this kind of manipulation appears so simple as to be trivial, but because PROJECT operators can in turn be pushed through any other relational operator—such as JOIN or UNION—applying this rule can vastly reduce the amount of data that must be handled in a query by pushing the PROJECT list from the entire query as close to the SCAN as possible.

### Pushing Dimensional FILTER Through MULTIPLY

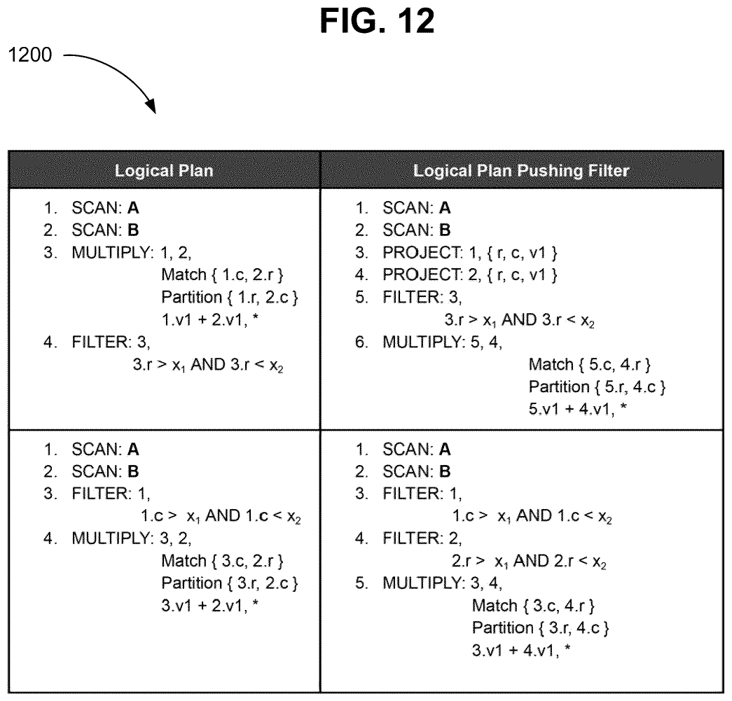

The second example of potential interaction between a relational and linear algebra operator more clearly represents an opportunity to improve query performance. If a query applies a FILTER to either the match or partition dimension columns, this FILTER can be modified and applied before the MULTIPLY operator thereby reducing the amount of data passed through the MULTIPLY. This idea is illustrated in table 1100 in FIG. 11.

FIG. 11 illustrates how a FILTER applied to the result of a MULTIPLY can be reformulated and pushed earlier in the logical query plan. In the first example a filter on the partition column(s) can be pushed before the MULTIPLY to reduce the amount of data the MULTIPLY must process. The second example illustrates how an entirely new FILTER can be inferred from the combination of a FILTER over the match columns and the semantics of MULTIPLY. Naturally, not all filters applied after the MULTIPLY can be pushed in front of it. For example, filters on the per-cell output values cannot be pushed earlier in the plan as the values to be filtered are created by the functioning of the MULTIPLY.

### Rewriting Queries With FILTER and MULTIPLY

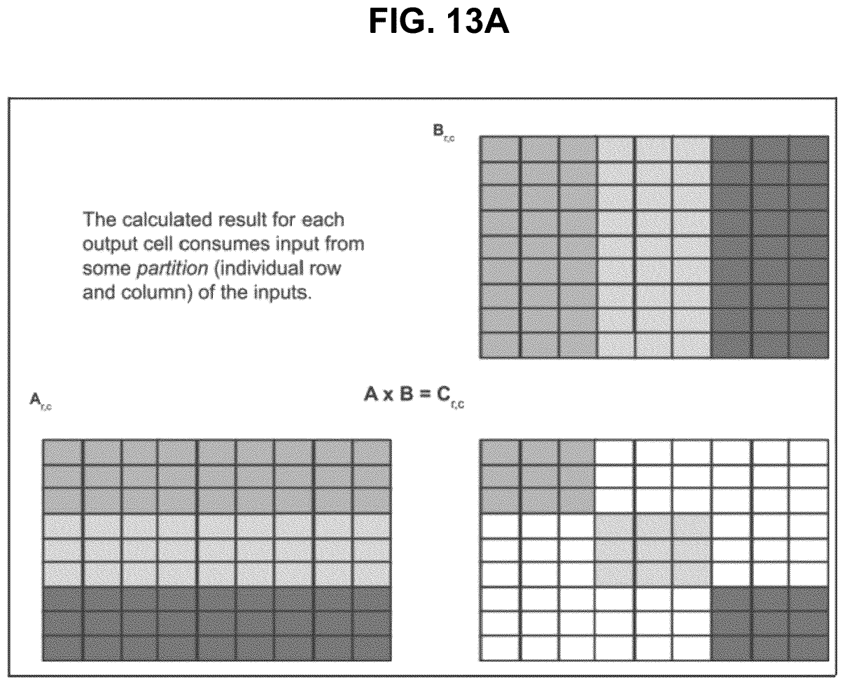

One of the properties of MULTIPLY is that the operation can be divided into multiple independent MULTIPLY operations that each address a partition of the input, and then the per-partition result can be combined into a whole, as illustrated in table 1200 in FIG. 12.

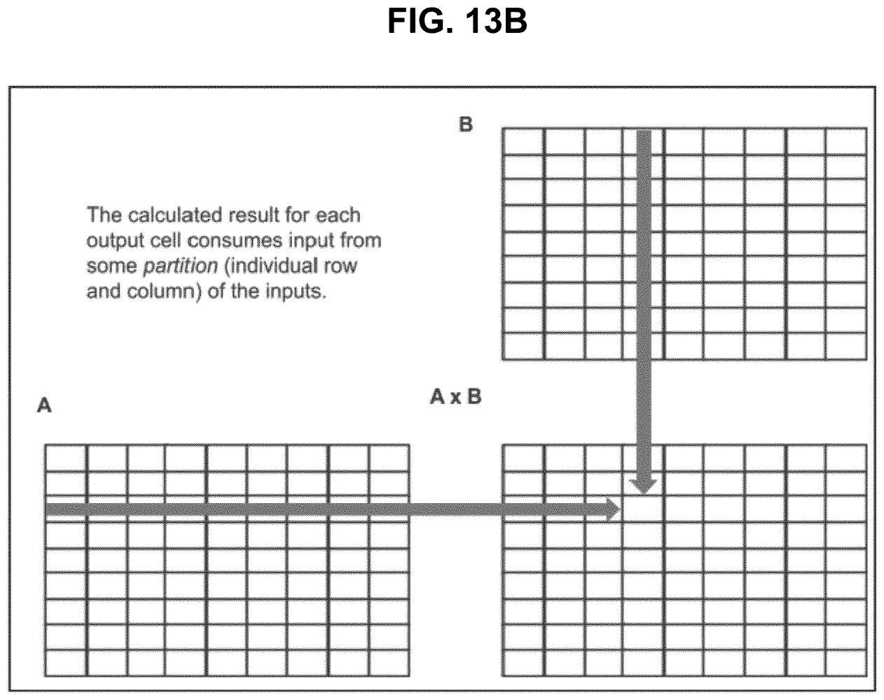

In formal terms, we can push a MULTIPLY before the UNION, and then combine the results of each MULTIPLY to produce the final result. The advantage of the re-written version of this query is that the cost of the two MULTIPLY operators might be less than the cost of the single, large MULTIPLY. This variation is illustrated in the example of FIGS. 13A and 13B. These three are each examples of a larger collection of potential re-arrangements of a logical query plan mixing relational and linear algebraic operators that the optimizer 208 can generate before estimating the computational cost of each alternative. Each of the examples above shows why a re-written query plan may require less compute power than some alternative. In practice, a large number of such rewrite rules can be generated by this kind of mathematical analysis.

### Logical Planning 2

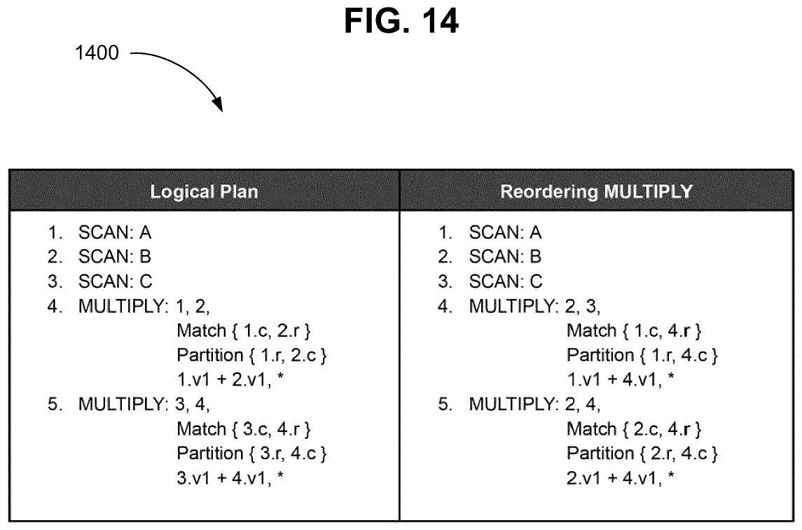

Rules for rewriting queries focusing on linear algebra operators may also be used. In the same manner that SQL query processing involves rearranging sequences of set-theoretic operators, a sequence of linear algebra operators can be rearranged into more or less efficient alternatives. The rules governing these rearrangements differ when considering linear algebra because the mathematical properties of relational operators differ from those of linear algebra operators. For example, for the most part, set theoretic operators are commutative, which means that a sequence of operators A op₁ B op₂ C can be restated as B op₂ C op₁ A. Matrix Multiplication is not commutative, although it is associative—A×B×C can be computed as ((A×B)×C or (A×(B×C))—which gives a planner options when it comes to execution order. An example of reordering is shown in table 1400 in FIG. 14.

To understand why this kind of reordering might be more efficient, consider a query that multiplies three MRelations: A_{r,c}×B_{r,c}×C_{r,c} yielding a result R_{Ar,Cc}. Recall that the computational cost of each MULTIPLY (A, B) is O (Aᵣ×A_{c}×B_{c}) with an output size of Aᵣ×B_{c}. It follows that if the computational cost of A_{r,c}×B_{r,c} is larger than B_{r,c}×C_{r,c} then the second form of the query plan—that is, (A×(B×C))—is to be preferred.

As with the relational operators, a query executor has a number of decisions to make about data structure and algorithm choices when physically executing a MULTIPLY operator, and a query executor which incorporates such a linear algebra operator would need to include a variety of these methods. In this section, we sketch several such physical methods and explain the trade-offs each involves.

All implementations of linear algebra operations rely on decomposing the input matrices into blocks, and then proceeds by performing a series of block-by-block steps and adding each block-by-block result to form the output. From the perspective of a SQL query processor the important point is that block-wise data structures are not a part of their executor implementations even though those executors typically rely on other quite specialized algorithms and data structures: for example, hashing, parallel sorts and merges, vectorized executors, machine code generation.

The ideal physical size for a block is also complicated by the way MULTIPLY (A, B) algorithms require (for efficiency) the alignment of blocks from MRelation inputs so that blocks from A contain columns that align with rows in blocks from B. That is, the A and B inputs must be partitioned into blocks Ablock_{i,j} and Bblock_{j,l}. A further complication—see below—has to do with the physical size difference between the sparse and dense blocks as further described.

Block level matrix multiply algorithms can benefit from different choices of data structure. When a block of data is dense—that is, when nearly all of the cells in the block have non-zero values—then the data is best organized as a 2-D array. However, if the data is sparse—that is, when many of the cells in the block have a zero value—the block is best organized using a compressed sparse row (“CSR”) format.

Regardless of the density of the input matrix it is also important that the physical block size is chosen carefully. In modern CPUs and GPUs there are throughput constraints moving data between DRAM and CPU or GPU cache. On the other hand, once data is moved into the CPU registers subsequent processing of the input blocks is very fast. Consequently, the developer is faced with the following trade-off: if the block is too physically small then the movement of multiple small data blocks between DRAM and CPU cache becomes a bottleneck, but if the block size is too large then the cost of each block-block operation becomes the bottleneck. And this trade-off is further complicated when the overall execution framework is obliged to work in a highly concurrent manner, with many distinct MULTIPLY operations scheduled simultaneously. The choice of per-block physical layout, and the decisions as to how many bytes per block is optimal, greatly affects the overall performance of both MULTIPLY operators and of concurrent workloads that involve many MULTIPLY operations at the same time.

A very large number of detailed algorithms for computing MULTIPLY exist. Many of these are quite specialized and deal with constrained so-called “corner cases” (for example, the result of an A×A^{T} can be produced by only computing the upper right corner of the result).

In addition to the low-level block organization decisions of the type described above, large scale MULTIPLY operations benefit from intra-node parallelism for the same reason relational operations can. In fact, the design and implementation of large scale—that is, parallel and distributed—linear algebra operations has been an ongoing topic of research in the high performance computing world for decades. The existing best practice is to partition input data into blocks and then to distribute these blocks over the compute nodes in what is known as a block-cyclic pattern. The parallel algorithm then “rotates” groups of data blocks through compute nodes in a manner that minimizes unnecessary data movement.

The challenge, from a SQL DBMS perspective, is to replicate these methods at scale. The problem is that practitioners using these methods in a HPC context can assume that their data has already been organized into blocks and pre-partitioned appropriately over compute nodes. Taking advantage of these methods within a SQL engine will require efficient methods to re-organize data from the row-oriented MRelation to blocks and back again.

The most obvious way to do this is to sort each of the input MRelations: the first (A) by its match columns, the second (B) by its match rows, and then partitions the input arrays into blocks and distribute them over the compute nodes according to the block-cyclic methods. This results in an O (|A.c|×log (|A.c|)) pre-step, but it has the advantage that once the sort is completed the planner will have a completely precise value on the ranges of values in the Match dimensions.

As you can see from the kinds of problems described in the previous few sections, an optimizer blending relational and linear algebra operators needs a great deal of detailed knowledge about the nature—size, shape, density, data type—of the data in the input MRelations. To best inform the decisions above

Below are well-known stages of query processing:
1. Connection Management/Security/Client Communication—this is the sub-problem that relates to establishing communications between the DBMS server and the external program, securing the connection, managing connection state, etc.
2. Query Parsing—this is the sub-problem of converting the SQL expression into a correct and coherent “white tree”. This is the most basic “does the query expression use SQL syntax in the right places”, etc.
3. Logical Parsing—this is the sub-problem of looking up the names of tables, columns, functions, etc that appear in the query and ensuring that the query is semantically coherent, given the database schema, connection state and user role.
4. Logical Plan Generation—this is the sub-problem that involves taking the logically adorned “white tree” and generating the set of corresponding logical operators from the SQL expression.
5. Heuristic Re-write—this is the sub-problem that involves re-ordering or re-arranging the logical operators according to a list of best practices rules. Things like pushing SELECT before JOIN or UNION, applying De Morgan's laws to re-write OR into NOT AND forms, etc.

These stages listed in 1. through 5. may be considered “static”, in the sense that the algorithms and methods are all “one pass over the data that makes up the query expression”. There is no need for any decision between alternatives. Either the results are correct or an error is observed. Moving beyond these static stages, more dynamic stages may occur:
6. Logical Optimization—this is the first “dynamic” problem, and it typically refers to “query optimization”. The idea is that the procedure starts with a sequence of logical operators {PROJECT (SELECT (JOIN (A, B), item1), item2} and it explores the space of possible logical plans (that is, all re-orderings/re-arrangements of these operators that are logically equivalent to the original) to identify which of the (very many) potential re-arrangements is the most efficient in terms (roughly) of how many “rows×columns” must be processed by the overall plan.
7. Physical Optimization—this is the second “dynamic” problem, and it is intimately tied to the first. The idea here is that for each logical operator, and indeed each “pair” of logical operators (that is the connection between the output of one operator and the input to another), the query planner picks from among a set of data manipulation algorithms. Again, the overall goal is to choose the plan that minimizes the overall computational costs.
   Now, the final stages to occur:
8. Query Execution—this is the sub-problem that deals with the actual data manipulation. That is, it's the part of query execution that actually touches the data in tables. And it is more complex than it sounds because this is the part that gets to do things like interact with Workload Management, throttling, etc.
9. Results Management—this is the sub-problem that deals with how results data is communicated back to the client. It's the other side of the coin for communication/connection management.

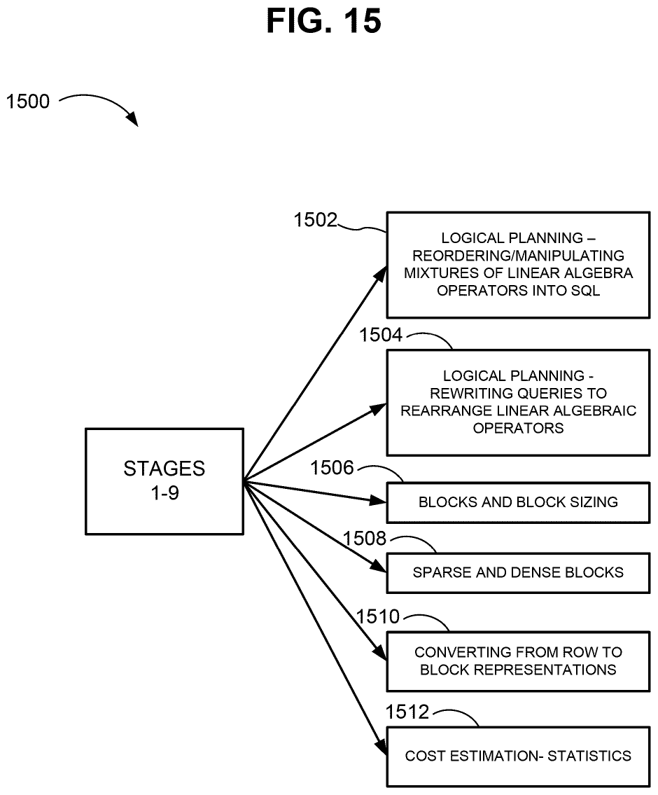

FIG. 15 is an example of how these various stages may be altered to accommodate matrix multiplication. In one example, the stages 1-9 may include logical planning (502) and logical planning (504). The stages may also include blocks and block sizing (506) and sparse/dense block considerations (508). The stages may also include converting from row-to-block representations (510). Cost estimations (512) related to the matrix multiplication may also be considered.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

I claim:

1. A system comprising:
a storage device;
a plurality of processing nodes in communication with the storage device, wherein at least one processing node of the plurality of processing nodes is configured to:
receive a declarative database syntax command to multiply matrices of data stored in the storage device; and
processing the declarative database syntax to complete the multiplication.
